(19) United States
(12) Patent Application Publication
(10) Pub. No.: US 2007/0008402 A1
(43) Pub. Date: Jan. 11, 2007

(54) Apparatus and method for backing up broadcast files

(75) Inventors: Jin-yong Ahn, Suwon-si (KR); Soo-kang Bae, Seongnam-si (KR); Jung-min Kang, Seoul (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/480,493

(22) Filed: Jul. 5, 2006

Related U.S. Application Data
(60) Provisional application No. 60/695,871, filed on Jul. 5, 2005.

(30) Foreign Application Priority Data
Jul. 13, 2005 (KR) 10-2005-0063427

(51) Int. Cl. H04N 7/14

(52) U.S. Cl. 348/14.04

(57) ABSTRACT

An apparatus and method for backing up broadcast files are provided. The apparatus includes a received file information analysis unit which analyzes package information included in a metadata file received from the digital broadcast apparatus and extracts storage location information and/or file name information regarding a broadcast file corresponding to the metadata file from the package information; a file request unit which transmits a message to the digital broadcast apparatus requesting the broadcast data file obtained by the received file information analysis unit; and a storage unit which receives the broadcast data file from the digital broadcast apparatus and stores the broadcast data file together with the metadata file in response to the message. Accordingly, it is possible to back up broadcast data files on a storage medium with a large storage capacity by referencing respective corresponding metadata files that are packaged together with the broadcast data files.

### CROSS-REFERENCE TO RELATED PATENT APPLICATIONS

This application claims priority from Korean Patent Application No. 10-2005-0063427, filed on Jul. 13, 2005, in the Korean Intellectual Property Office, and U.S. Provisional Application No. 60/695,871, filed on Jul. 5, 2005, in the U.S. Patent and Trademark Office, the disclosures of which are incorporated herein in their entirety by reference.

### BACKGROUND OF THE INVENTION

1. Field of the Invention

Apparatuses and methods consistent with the present invention relate to backing up broadcast files, and more particularly, to backing up broadcast files, wherein broadcast files stored in a digital broadcast reception device are backed up on a storage device having a large storage capacity, and are executed from the storage device.

2. Description of the Related Art

In the related art, digital broadcast reception devices equipped with storage media, such as hard discs, have been developed and commercialized. Such related art digital broadcast reception devices can receive a broadcast program chosen by a user, and store the received broadcast program in their respective storage media.

FIG. 1 is a block diagram of a related art digital broadcast reception device 100 which can store a broadcast program. Referring to FIG. 1, the digital broadcast reception device 100 includes a tuner and demodulator unit 110, a demultiplexing unit 120, a signal processing unit 130, a synchronization unit 140, a storage unit 150, a user interface unit 160, and a control unit 170. The signal processing unit 130 includes an audio/video (A/V) signal processor 132, an application information processor 134, and an electronic program guide (EPG) information processor 136.

A transport stream input to a digital broadcast reception device is encoded according to predetermined broadcasting standards. A broadcast program transport stream into which a plurality of transport streams generated by a plurality of broadcasting stations are multiplexed is received by a broadcast reception device via a single channel band.

A broadcast program transport stream includes A/V signals produced by a broadcasting station, application information, which is an application program for providing various additional services related to the A/V signals to viewers, and EPG information for helping viewers choose broadcast programs to watch. The application information and EPG information are included in a predetermined portion of a data stream.

The tuner and demodulator unit 110 receives a broadcast program transport stream input to the digital broadcast reception device 100 via an antenna ANT, demodulates the broadcast program transport stream, and transmits the demodulated result to the demultiplexing unit 120 under the control of the control unit 170.

The demultiplexing unit 120 separates A/V signals, application information, and EPG information from the broadcast program transport stream transmitted by the tuner and demodulator unit 110 and transmits the A/V signals, the application information, and the EPG information to the A/V signal processor 132, the application information processor 134, and the EPG information processor 136.

The A/V signal processor 132 processes the A/V signals received from the demultiplexing unit 120, thereby generating an A/V file. More specifically, the A/V signal processor 132 may delete some of the received A/V signals that are set not to be stored according to a user's settings via the user interface unit 160, and packages the rest of the received A/V signals as an A/V file. The generation of the A/V file may be characterized as converting a set of A/V signals having a transport stream format into an A/V file having a typical file format.

The application information processor 134 processes the application information received from the demultiplexing unit 120, thereby generating an application file having a file format. The generation of the application file may be interpreted as converting application information in a transport stream format that is mapped according to broadcasting standards into an application file having a related art file format.

The EPG information processor 136 processes the EPG information received from the demultiplexing unit 120, thereby generating an EPG file. The generation of the EPG file may be characterized as converting EPG information in a transport stream format that is mapped according to broadcasting standards into an EPG file having a related art file format. The EPG file may be an XML file or a metadata-type file according to the Movie Picture Video (MPV) standard used.

More specifically, the EPG information processor 136 deletes unnecessary portions of the received EPG information having a transport stream format and adds additional information, if any, to the remainder of the received EPG information. The additional information may be storage date/time information and storage device information.

The storage date/time information may be inserted into a predetermined portion of the EPG information with reference to time information provided by a timer (not shown) connected to the control unit 170.

The storage device information which has already been stored in the storage unit 150 may be inserted into a predetermined portion of the EPG information.

The synchronization unit 140 receives the A/V file, the application file, and the EPG file from the A/V signal processor 132, the application information processor 134, and the EPG information processor 136, respectively, in a predetermined approach. The synchronization unit 140 synchronizes the A/V file, the application file, and the EPG file with one another, which will be described in detail.

The synchronization unit 140 sets storage information for each of the A/V file and the application file and adds the storage information for the A/V file and the application file to the EPG file. The storage information for the A/V file and the application file specifies the locations of directories in which the A/V file and the application file are respectively stored and the names of the A/V file and the application file.

The A/V file and the application file stored in the synchronization unit 140 constitute a broadcast data file, and the EPG file including the storage information for the A/V file and the application file is stored in the storage unit 150 as a metadata file.

The storage unit 150 stores the broadcast data file comprised of the A/V file and the application file and metadata comprising the EPG file including the storage information for the A/V file and the application file.

The user interface unit 160 provides an input/output interface which is connected to the control unit 170. A command for controlling the digital broadcasting apparatus 100 is received from the user via the user interface unit 160. However, the digital broadcasting apparatus 100 has a limited storage capacity and thus cannot store all of the broadcast files that the user desires to store therein.

In addition, when the user wants to back up broadcast files stored in the digital broadcasting apparatus 100, he or she must search for storage location information and file name information regarding the broadcast files, which is inconvenient.

### SUMMARY OF THE INVENTION

The present invention provides an apparatus and method for backing up broadcast files on a storage medium having a large storage capacity, in which broadcast data file information is detected by analyzing a metadata file having package information and broadcast files packaged together are backed up on a storage medium having a large storage capacity with reference to the broadcast data file information.

According to an aspect of the present invention, there is provided an apparatus for backing up broadcast files stored in a digital broadcast apparatus, each of the broadcast files comprising a broadcast data file and a metadata file including package information regarding elements of the broadcast data file. The apparatus includes a received file information analysis unit which analyzes package information included in a metadata file received from the digital broadcast apparatus and extracts storage location information and/or file name information regarding a broadcast file corresponding to the metadata file from the package information; a file request unit which transmits a message to the digital broadcast apparatus requesting the broadcast data file corresponding to the storage location information and/or the file name information obtained by the received file information analysis unit; and a storage unit which receives the broadcast data file from the digital broadcast apparatus and stores the broadcast data file together with the metadata file in response to the message.

According to another aspect of the present invention, there is provided an apparatus for backing up broadcast files stored in a digital broadcast apparatus, each of the broadcast files comprising a broadcast data file and a metadata file including package information specifying that the broadcast data file is packaged together with the metadata file. The apparatus includes a received file information analysis unit which analyzes package information included in a metadata file received from the digital broadcast apparatus and extracts storage location information and/or file name information regarding a broadcast file corresponding to the metadata file from the package information; a file request unit which transmits a message to the digital broadcast apparatus requesting the broadcast data file corresponding to the storage location information and/or the file name information obtained by the received file information analysis unit; a file information conversion unit which converts the package information included in the metadata file so that the storage location information and/or the file name information obtained by the received file information analysis unit can be changed with an approach; and a storage unit which receives the broadcast data file from the digital broadcast apparatus, stores the broadcast data file in response to the message using the converted package information, and stores the metadata file containing the converted package information.

According to another aspect of the present invention, there is provided a method of backing up broadcast files stored in a digital broadcast apparatus, each of the broadcast files comprising a broadcast data file and a metadata file including package information regarding elements of the broadcast data file. The method includes analyzing package information included in a metadata file received from the digital broadcast apparatus and extracting storage location information and/or file name information regarding a broadcast file corresponding to the metadata file from the package information; transmitting a message to the digital broadcast apparatus requesting the broadcast data file corresponding to the storage location information and/or the file name information; and storing the broadcast data file received from the digital broadcast apparatus and the metadata file in a storage unit in response to the message.

According to another aspect of the present invention, there is provided a method of backing up broadcast files stored in a digital broadcast apparatus, each of the broadcast files comprising a broadcast data file and a metadata file including package information specifying that the broadcast data file is packaged together with the metadata file. The method includes analyzing package information included in a metadata file received from the digital broadcast apparatus and extracting storage location information and/or file name information regarding a broadcast file corresponding to the metadata file from the package information; transmitting a message to the digital broadcast apparatus requesting the broadcast data file corresponding to the storage location information and/or the file name information; converting the package information included in the metadata file so that the storage location information and/or the file name information can be changed using an approach; and storing the broadcast data file received from the digital broadcast apparatus in a storage unit in response to the message using the converted package information and storing the metadata file containing the converted package information.

According to another aspect of the present invention, there is provided a computer-readable recording medium storing a computer program for executing the method of backing up broadcast files stored in a digital broadcast apparatus.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art digital broadcast reception device which can store a broadcast program;

FIG. 2 is a block diagram of an apparatus for backing up broadcast files according to an exemplary embodiment of the present invention;

FIG. 3 is a detailed block diagram of an execution unit of FIG. 2;

FIG. 4 is a flowchart illustrating a method of backing up broadcast files according to an exemplary embodiment of the present invention; and

FIG. 5 is a flowchart illustrating a method of executing broadcast files backed up on a storage medium having a large storage capacity using the method of FIG. 4, according to an exemplary embodiment of the present invention.

### DETAILED DESCRIPTION OF EXEMPLARY EMBODIMENTS OF THE INVENTION

The present invention will now be described more fully with reference to the accompanying drawings in which exemplary embodiments of the invention are shown.

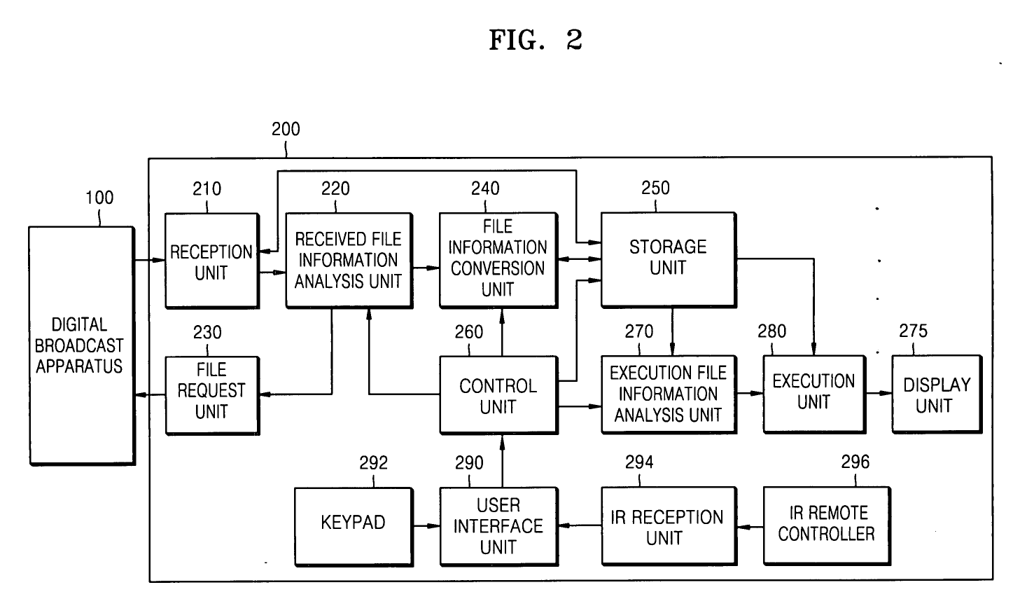

FIG. 2 is a block diagram of an apparatus 200 for backing up broadcast files according to an exemplary embodiment of the present invention. The broadcast file backup apparatus 200 includes a reception unit 210, a received file information analysis unit 220, a file request unit 230, a file information conversion unit 240, a storage unit 250, a control unit 260, an execution file information analysis unit 270, a display unit 275, an execution unit 280, and a user interface unit 290. The broadcast file backup apparatus 200 may also include units other than those illustrated in FIG. 2 to perform its operations, but the units not illustrated in FIG. 2 are not described in this disclosure for the sake of clarity and brevity.

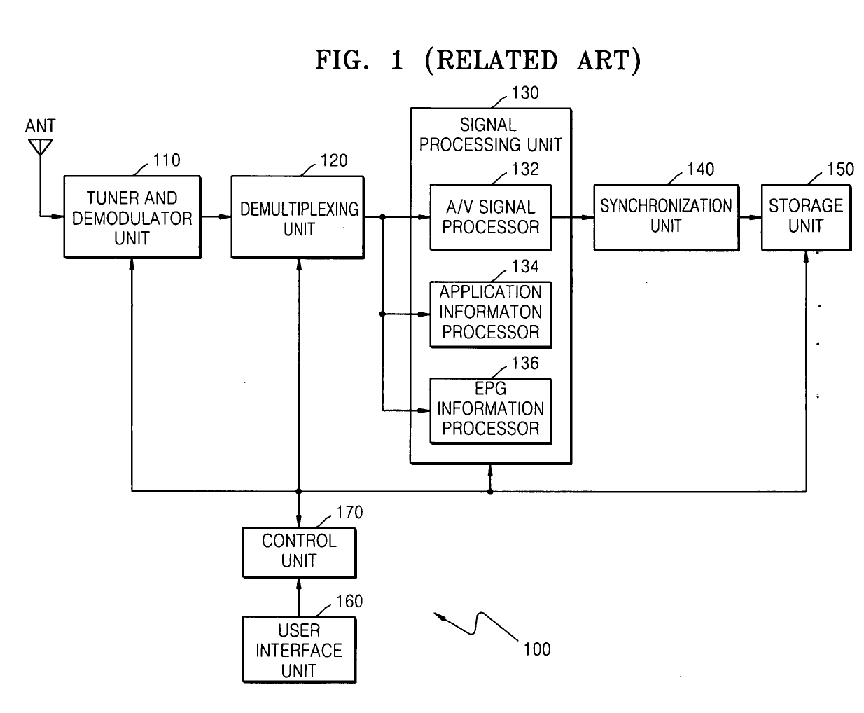

The related art digital broadcasting apparatus 100 of FIG. 1 stores a plurality of broadcast files, each comprising a broadcast data file and a metadata file including package information regarding elements of the broadcast data file. More specifically, the broadcast data file comprises an A/V file and an application file, and the metadata file comprises package information regarding the A/V file and the application file. The metadata file also comprises EPG information. The digital broadcasting apparatus 100 may be a digital multimedia broadcasting (DMB) device or a digital set-top box.

The broadcast data file and the metadata file stored in the digital broadcasting apparatus 100 have already been described with reference to FIG. 1.

The reception unit 210 receives a metadata file to be stored in the broadcast file backup apparatus 200 from the digital broadcasting apparatus 100. The metadata file received from the reception unit 210 is included in one of the broadcast files stored in the digital broadcasting apparatus 100 that is chosen to be backed up in the broadcast file backup apparatus 200 by a user.

More specifically, the digital broadcasting apparatus 100 displays a list of metadata files for the respective broadcast files stored therein. The user may choose one of the broadcast files, for example but not by way of limitation, a broadcast file containing a news broadcast aired at 9 PM on Jul. 13, 2005 by the Korean Broadcasting Station (KBS), with reference to the metadata file list. In addition, the reception unit 210 also receives a broadcast data file comprising an A/V file and an application file from the digital broadcasting apparatus 100. The reception of the broadcast data file is described in greater detail below in association with the operation of the file request unit 230.

The transmission of the metadata file and the broadcast data file between the reception unit 210 and the digital broadcasting apparatus 100 may be carried out using a wired or wireless channel. The received file information analysis unit 220 analyzes package information included in the metadata file received from the reception unit 210 and extracts storage location information and/or file name information regarding the broadcast data file that is expected to be packaged together with the metadata file. The analysis of the package information included in the metadata file may be interpreted as extraction of the storage location information and/or the file name information regarding an A/V file and an application file constituting the broadcast data file.

For example but not by way of limitation, the received file information analysis unit 220 can analyze metadata comprising the storage location information and/or the file name information regarding the A/V file and the application file constituting the broadcast file containing the news broadcast aired at 9 PM on Jul. 13, 2005 by the KBS and obtain the storage location information and/or the file name information as analysis results.

The file request unit 230 receives the storage location information and/or the file name information obtained by the received file information analysis unit 220, and transmits a message requesting the broadcast data file corresponding to the storage location information and/or the file name information to the digital broadcasting apparatus 100. The transmission of the message from the file request unit 230 to the digital broadcast device 100 may be carried out via a wired or wireless channel.

The digital broadcast apparatus 100 searches for the requested broadcast data file corresponding to the storage location information and/or the file name information in response to the reception of the message transmitted by the file request unit 230, and transmits the requested broadcast data file to the reception unit 210.

The file information conversion unit 240 appropriately converts the storage location information and/or the file name information obtained by the received file information analysis unit 220 using an approach. For example but not by way of limitation, the file information conversion unit 240 may convert the storage location information and/or the file name information obtained by the received file information analysis unit 220 using a default storage approach set in the broadcast file backup apparatus 200 or using a storage approach corresponding to a value input by the user with the aid of the user interface unit 290.

More specifically, when the digital broadcasting apparatus 100 and the broadcast file backup apparatus 200 adopt different storage approaches, the storage location information and/or the file name information obtained by the received file information analysis unit 220 may be converted using the default storage approach.

When the user inputs a value to the broadcast file backup apparatus 200 via the user interface unit 290 indicating that the storage location information and/or the file name information obtained by the received file information analysis unit 220 is to be converted using a storage approach, the storage location information and/or the file name information obtained by the received file information analysis unit 220 may be converted using the storage approach corresponding to the value input by the user.

The storage location information and/or the file name information obtained by the received file information analysis unit 220 may be converted using a storage approach other than the default storage approach and the storage approach corresponding to the value input by the user.

The file information conversion unit 240 may determine whether the storage location information obtained by the received file information analysis unit 220 indicates that the broadcast data file is already stored in the storage unit 250, or whether a match for the file name information obtained by the received file information analysis unit 220 exists in the storage unit 250 before converting the storage location information and/or the file name information.

If the location designated by the storage location information obtained by the received file information analysis unit 220 is not in the storage unit 250, or if no match for the file name information obtained by the received file information analysis unit 220 exists in the storage unit 250, the storage location information and/or the file name information may be converted using the default storage approach or using the storage approach corresponding to the value input by the user.

On the other hand, if the location designated by the storage location information obtained by the received file information analysis unit 220 is in the storage unit or if the match for the file name information obtained by the received file information analysis unit 220 exists in the storage unit 250, the storage location information and/or the file name information may be converted using a conversion approach in which for example but not by way of limitation a serial number is attached to the storage location information and/or the file name information, thereby preventing the broadcast data file corresponding to the storage location information and/or the file name information from conflicting with other broadcast data files previously stored in the storage unit 250.

The storage unit 250 may be a storage medium, such as a hard disc drive (HDD) or an electrically erasable programmable read-only memory (EEPROM). The storage unit 250 may have a storage capacity sufficient to serve as a backup device for the digital broadcasting apparatus 100, thereby reducing the possibility of a storage shortage. The storage unit 250 stores a metadata file received from the file information conversion unit 240 and a broadcast data file received from the reception unit 210. The storage unit 250 may change the file name of the broadcast data file received from the reception unit 210 with reference to file name information included in package information included in the metadata file received from the file information conversion unit 240 and may store the broadcast data file in a location corresponding to storage location information included in the package information included in the metadata file received from the file information conversion unit 240 under the changed file name.

As described above, if the location designated by the storage location information obtained by the received file information analysis unit 220 exists in the storage unit 250, or if the match for the file name information obtained by the received file information analysis unit 220 exists in the storage unit 250, the storage location information and/or the file name information may be converted using a conversion approach in which, for example but not by way of limitation, a serial number, is attached to the storage location information and/or the file name information, and the broadcast data file received from the reception unit 210 may be stored with reference to the converted results, thereby preventing the broadcast data file from conflicting with other broadcast data files stored in the storage unit 250.

The user interface unit 290 is connected to the control unit 260 and provides an input/output interface via which a command for controlling the broadcast file backup apparatus 200 is received from the user.

More specifically, the user interface unit 290 may be replaced with an infrared ray (IR) reception unit 294 which interprets a command input via a keypad 292 or an IR remote control 296. The IR remote control 296 may be a cordless mouse or a related art remote control.

If the user chooses one of a plurality of metadata files stored in the storage unit 250 to be executed using the user interface unit 290, the execution file information analysis unit 270 analyzes the package information included in the chosen metadata file and extracts the storage location information and/or the file name information regarding the broadcast data file that is packaged together with the metadata file with reference to the analysis results.

The execution unit 280 downloads the broadcast data file corresponding to the storage location information and/or the file name information obtained by the execution file information analysis unit 270 from the storage unit 250 and then executes the downloaded broadcast data file.

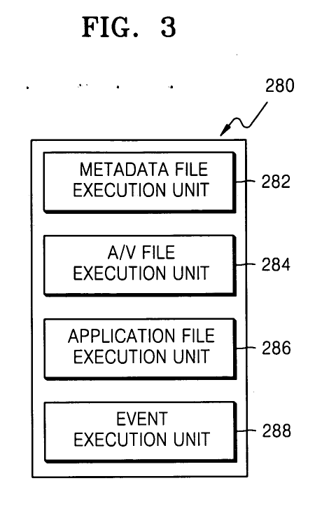

The structure and operation of the execution unit 280 is described detail with reference to FIG. 3, which is a detailed block diagram of the execution unit 280 of FIG. 2. The execution unit 280 includes a metadata file execution unit 282, an A/V file execution unit 284, an application file execution unit 286, and an event execution unit 288.

The metadata file execution unit 282 executes the metadata file received from the execution file information analysis unit 270. Thereafter, the metadata file execution unit 282 may display the metadata at the display unit 275. If a broadcast event signal is detected during the execution of the metadata file, the metadata file execution unit 282 outputs the broadcast event signal to the event execution unit 288.

The A/V file execution unit 284 downloads an A/V file from the storage unit 250 and reproduces the A/V file using the display unit 275. If a broadcast event signal is detected during the processing of the A/V file, the A/V file execution unit 284 outputs the broadcast event signal to the event execution unit 288. During the execution of the A/V file, the detected event signal may be reproduction time information.

The application execution unit 286 downloads an application file from the storage unit 250, executes the application file, and displays the result using the display unit 275. In addition, if a broadcast event signal is detected during the execution of the application file, the application execution unit 286 outputs the broadcast event signal to the event execution unit 288.

The event execution unit 288 receives event signals from the metadata file execution unit 282, the A/V file execution unit 284, and the application execution unit 286. In addition, if a user event signal chosen by the user via the user interface unit 290 is input to the event execution unit 288 via the control unit 260, the event execution unit 288 processes the user event signal. The event execution unit 288 may control the operations of the metadata file execution unit 282, the A/V file execution unit 284, and the application execution unit 286 in response to the event signals.

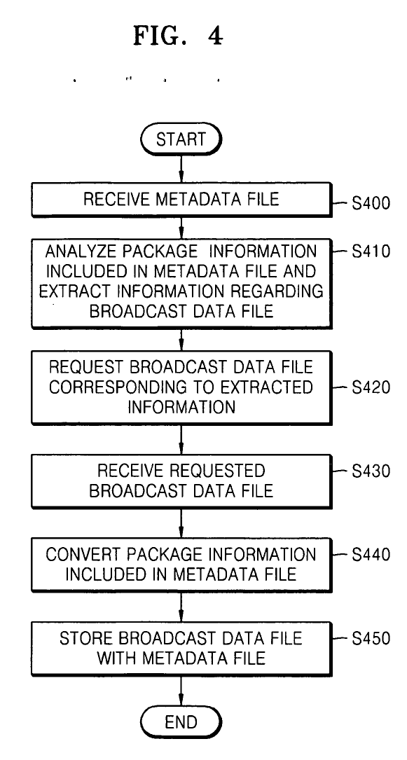

FIG. 4 is a flowchart illustrating a method of backing up broadcast files according to an exemplary embodiment. In operation S400, a metadata file to be backed up in a broadcast file backup apparatus is received from a digital broadcasting apparatus in which a plurality of metadata files are stored. The received metadata file is selected by a user from among the metadata files stored in the broadcast file backup apparatus.

In operation S410, package information included in the received metadata file is analyzed, and storage location information and/or file name information regarding a broadcast data file that is packaged together with the received metadata file is extracted with reference to the analyzed results.

In operation S420, a message requesting a broadcast data file corresponding to the storage location information and/or the file name information obtained in operation S410 is transmitted to the digital broadcasting apparatus.

In operation S430, the broadcast data file corresponding to the storage location information and/or the file name information obtained in operation S410 is received.

In operation S440, the storage location information and/or the file name information obtained in operation S410 is converted using an approach that may be a default storage approach in the broadcast file backup apparatus or using a storage approach corresponding to a value input by the user via a user interface unit. However, the foregoing approach may be a storage approach other than those set forth herein.

In operation S440, the converting of the storage location information and/or the file name information obtained in operation S410 may comprise determining whether a broadcast data file is already stored in a location of a storage unit designated by the storage location information obtained in operation S410 or if a match for the file name information obtained in operation S410 exists in the storage unit.

In operation S450, the broadcast data file received in operation S430 and a metadata file obtained in operation S440 as the result of the conversion are stored. More specifically, the name of the received broadcast data file may be changed with reference to file name information included in the metadata file, and the received broadcast data file may be stored with the changed file name in a location corresponding to storage location information included in the metadata file.

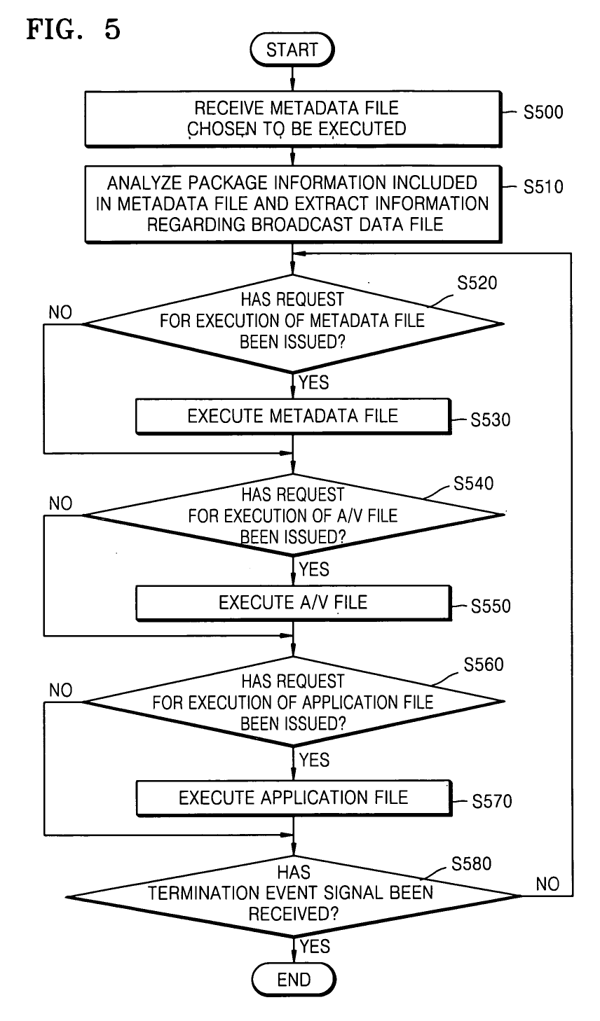

FIG. 5 is a flowchart illustrating a method of executing a broadcast data file backed up using the method illustrated in FIG. 4 according to an exemplary embodiment. A broadcast data file may comprise an A/V file and an application file.

Referring to FIG. 5, in operation S500, a metadata file corresponding to a broadcast data file chosen to be executed by a user via a user interface unit is received.

In operation S510, package information included in the received metadata file is analyzed, thereby obtaining storage location information and/or file name information regarding a broadcast data file that is packaged together with the received metadata file.

In operation S520, it is determined whether a request for execution of the received metadata file has been issued. In operation S530, if it is determined in operation S520 that the request for execution of the received metadata file has been issued (i.e., received), the received metadata file is executed. In operation S530, the executed result may optionally be displayed using a display unit. In addition, in operation S530, if a broadcast event signal is detected during the execution of the received metadata file, the broadcast event signal may be executed. The broadcast event signal may be an interface signal input by the user, and particularly, a metadata file execution requesting signal input by the user.

On the other hand, if it is determined in operation S520 that the request for execution of the received metadata file has not yet been received or issued, the method proceeds to operation S540. In operation S540, it is determined whether a request for execution of an A/V file included in the broadcast data file chosen to be executed has been issued.

In operation S550, if it is determined in operation S540 that the request for execution of the A/V file has been issued, the A/V file is executed.

In operation S550, the executed result may be displayed, if necessary, using the display unit. In addition, in operation S550, if a broadcast event signal is detected during the execution of the A/V file, the broadcast event signal may be executed. The broadcast event signal may be an interface signal input by the user, for example, an A/V file execution request signal input by the user.

On the other hand, if it is determined in operation S540 that the request for execution of the A/V file has not yet been received, the method proceeds to operation S560.

In operation S560, it is determined whether a request for execution of an application file included in the broadcast data file chosen to be executed has been issued. In operation S570, if it is determined in operation S560 that the request for execution of the application file has been issued, the application file is executed. In operation S570, the executed result may be displayed, if necessary, using the display unit. In addition, if a broadcast event signal is detected during the execution of the application file, the broadcast event signal may be executed. The broadcast event signal may be an interface signal input by the user, for example, an application file execution request signal input by the user.

On the other hand, if it is determined in operation S560 that the request for execution of the application file has not yet been received, the method proceeds to operation S580. In operation S580, it is determined whether a termination event signal for the broadcast data file chosen to be executed has been received. The termination event signal may be a termination signal or an A/V reproduction termination signal input by the user. If it is determined in operation S580 that the termination event signal for the broadcast data file chosen to be executed has been received, the method is terminated. Otherwise, the method returns to operation S520.

The exemplary embodiments can be realized as computer-readable code stored in a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the exemplary embodiment can be easily construed by one of ordinary skill in the art.

According to the exemplary embodiment, it is possible to back up on a storage medium with a large storage capacity broadcast data files that are packaged in a digital broadcast apparatus (e.g., a digital multimedia broadcasting (DMB) device) together with respective corresponding metadata files with reference to package information included in the respective corresponding metadata files. In other words, it is possible to back up the broadcast data files without user intervention by analyzing the respective corresponding metadata files.

In addition, it is possible to back up the broadcast data files on the storage medium without user intervention by appropriately converting storage location information and/or file name information regarding the broadcast data files if other broadcast data files are stored in locations designated by the storage location information or if other broadcast data files with the same file names as the broadcast data files are stored.

Moreover, it is possible to execute the broadcast data files backed up on the storage medium without performing additional processes by installing a module for executing backup broadcast data files in the storage medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for backing up broadcast files stored in a digital broadcast apparatus, each of the broadcast files comprising a broadcast data file and a metadata file including package information for elements of the broadcast data file, the apparatus comprising:
a received file information analysis unit which analyzes package information included in a metadata file received from the digital broadcast apparatus, and extracts at least one of storage location information and file name information regarding a broadcast file corresponding to the metadata file from the package information;
a file request unit which transmits a message to the digital broadcast apparatus requesting the broadcast data file corresponding to the at least one of the storage location information and the file name information extracted by the received file information analysis unit; and
a storage unit which receives the broadcast data file from the digital broadcast apparatus and stores the broadcast data file together with the metadata file in response to the message.

2. The apparatus of claim 1, further comprising a reception unit which receives the metadata file from the digital broadcast apparatus, outputs the metadata file to the received file information analysis unit, receives the broadcast data file from the digital broadcast apparatus, and outputs the broadcast data file to the storage unit.

3. The apparatus of claim 1 further comprising:
an execution file information analysis unit which analyzes the package information included in the metadata file stored in the storage unit that is chosen to be executed, and extracts from the package information at least one of storage location information and file name information regarding a broadcast file that is packaged together with the metadata file chosen to be executed; and
an execution unit which downloads the broadcast file from the storage unit with reference to at least one of the storage location information and the file name information extracted by the execution file information analysis unit and executes the downloaded broadcast file.

4. The apparatus of claim 3, further comprising a user interface unit which outputs a selection signal so that the metadata file chosen to be executed can be selected from the storage unit.

5. The apparatus of claim 3, wherein each of the broadcast data files comprises an audio/video (A/V) file and an application file, and
wherein the execution unit comprises:
a metadata file execution unit which executes the metadata file received from the execution file information analysis unit;
an A/V file execution unit which executes an A/V file received from the execution file information analysis unit; and
an application file execution unit which downloads an application file from the storage unit with reference to the at least one of the storage location information and the file name information extracted by the execution file information analysis unit and executes the downloaded application file.

6. The apparatus of claim 5, wherein the execution unit further comprises an event execution unit which receives a broadcast event signal detected by the metadata file execution unit, the A/V file execution unit, or the application execution unit or a broadcast event signal generated in response to a user interface signal and carries out a broadcast event corresponding to the received broadcast event signal, wherein the event execution unit controls the metadata file execution unit, the A/V file execution unit, and the application execution unit, according to the received broadcast event signal.

7. The apparatus of claim 1, wherein, if a match for the file name information obtained by the received file information analysis unit exists in the storage unit, the file names of the broadcast data file and the metadata file are changed, and the broadcast data file and the metadata file are stored in the storage unit with the changed file names of the broadcast data file and the metadata file.

8. The apparatus of claim 1, wherein the broadcast data file comprises an audio/video file and an application file.

9. The apparatus of claim 1, wherein the metadata file comprises the package information regarding elements of the broadcast data file and electronic program guide information.

10. An apparatus for backing up broadcast files stored in a digital broadcast apparatus, each of the broadcast files comprising a broadcast data file and a metadata file including package information specifying that the broadcast data file is packaged together with the metadata file, the apparatus comprising:
a received file information analysis unit which analyzes package information included in a metadata file received from the digital broadcast apparatus and extracts at least one of storage location information and file name information regarding a broadcast file corresponding to the metadata file from the package information;
a file request unit which transmits a message to the digital broadcast apparatus requesting the broadcast data file corresponding to the at least one of the storage location information and the file name information extracted by the received file information analysis unit;
a file information conversion unit which converts the package information included in the metadata file so that the at least one of the storage location information and the file name information extracted by the received file information analysis unit can be changed; and
a storage unit which receives the broadcast data file from the digital broadcast apparatus, stores the broadcast data file in response to the message using the converted package information, and stores the metadata file containing the converted package information.

11. The apparatus of claim 10, further comprising a reception unit which receives the metadata file from the digital broadcast apparatus, outputs the metadata file to the received file information analysis unit, receives the broadcast data file from the digital broadcast apparatus, and outputs the broadcast data file to the storage unit.

12. The apparatus of claim 10, wherein the file information conversion unit converts the package information included in the metadata file so that the at least one of the storage location information and the file name information extracted by the received file information analysis unit can be changed using a storage approach set as a default in the apparatus.

13. The apparatus of claim 10, further comprising a user interface unit which allows a user to convert the package information included in the metadata file through user settings so that the at least one of the storage location information and the file name information extracted by the received file information analysis unit can be changed according to the user settings.

14. The apparatus of claim 10, further comprising:
an execution file information analysis unit which analyzes package information included in one of a plurality of metadata files stored in the storage unit that is chosen to be executed and extracts from the package information at least one of storage location information and the file name information regarding a broadcast file that is packaged together with the metadata file chosen to be executed; and
an execution unit which downloads the broadcast file from the storage unit with reference to the at least one of the storage location information and the file name information extracted by the execution file information analysis unit and executes the downloaded broadcast file.

15. The apparatus of claim 14, further comprising a user interface unit which outputs a selection signal so that the metadata file chosen to be executed can be selected from the storage unit.

16. The apparatus of claim 14, wherein each of the broadcast data file comprises an A/V file and an application file, and the execution unit comprises:
a metadata file execution unit which executes a metadata file received from the execution file information analysis unit;
an A/V file execution unit which executes an A/V file received from the execution file information analysis unit; and
an application file execution unit which downloads an application file from the storage unit with reference to the at least one of the storage location information and the file name information extracted by the execution file information analysis unit and executes the downloaded application file.

17. The apparatus of claim 16, wherein the execution unit further comprises an event execution unit which receives a broadcast event signal detected by the metadata file execution unit, the A/V file execution unit, and the application execution unit or a broadcast event signal generated in response to a user interface signal and carries out a broadcast event corresponding to the received broadcast event signal, wherein the event execution unit controls the metadata file execution unit, the A/V file execution unit, and the application execution unit according to the received broadcast event signal.

18. The apparatus of claim 10, wherein the broadcast data file comprises an audio/video file and an application file.

19. The apparatus of claim 10, wherein the metadata file comprises the package information regarding elements of the broadcast data file and electronic program guide information.

20. A method of backing up broadcast files stored in a digital broadcast apparatus, each of the broadcast files comprising a broadcast data file and a metadata file including package information regarding elements of the broadcast data file, the method comprising:
analyzing package information included in a metadata file received from the digital broadcast apparatus and extracting at least one of storage location information and file name information regarding a broadcast file corresponding to the metadata file from the package information;
transmitting a message to the digital broadcast apparatus requesting the broadcast data file corresponding to the at least one of the storage location information and the file name information regarding the broadcast file corresponding to the metadata file; and
storing the broadcast data file received from the digital broadcast apparatus and the metadata file in a storage unit in response to the message.

21. The method of claim 20 further comprising:
analyzing package information included in a stored metadata file chosen to be executed and extracting from the package information at least one of storage location information and the file name information regarding a broadcast file that is packaged together with the stored metadata file chosen to be executed; and
downloading the broadcast file from the storage unit with reference to the at least one of the storage location information and the file name information regarding the broadcast file that is packaged together with the stored metadata file chosen to be executed, and executing the downloaded broadcast file.

22. The method of claim 21, wherein the storing comprises:
determining whether a match for the file name information exists in the storage unit;
changing the file names of the broadcast data file and the metadata file if the match for the file name information exists in the storage unit; and
storing the broadcast data file and the metadata file in the storage unit with the changed file names.

23. A method of backing up broadcast files stored in a digital broadcast apparatus, each of the broadcast files comprising a broadcast data file and a metadata file including package information specifying that the broadcast data file is packaged together with the metadata file, the method comprising:
analyzing package information included in a metadata file received from the digital broadcast apparatus and extracting at least one of storage location information and file name information regarding a broadcast file corresponding to the metadata file from the package information;
transmitting a message to the digital broadcast apparatus requesting the broadcast data file corresponding to the at least one of the storage location information and the file name information regarding the broadcast file corresponding to the metadata file;
converting the package information included in the metadata file so that the at least one of the storage location information and the file name information regarding the broadcast file corresponding to the metadata file can be changed; and
storing the broadcast data file received from the digital broadcast apparatus in a storage unit in response to the message using the converted package information and storing the metadata file containing the converted package information.

24. The method of claim 23, wherein the converting comprises converting the package information included in the metadata file so that the at least one of the storage location information and the file name information regarding the broadcast file corresponding to the metadata file can be changed using a storage approach set as a default in the apparatus.

25. The method of claim 23, wherein the converting comprises interfacing with a user so that the at least one of the storage location information and the file name information regarding the broadcast file corresponding to the metadata file can be changed in an approach chosen by the user.

26. The method of claim 23 further comprising:
analyzing package information included in a stored metadata file that is chosen to be executed and extracting from the package information at least one of storage location information and file name information regarding a broadcast file that is packaged together with the metadata file chosen to be executed; and
downloading the broadcast file from the storage unit with reference to at least one of the storage location information and the file name information regarding the broadcast file that is packaged together with the metadata file chosen to be executed, and executing the downloaded broadcast file.

27. The method of claim 26, further comprising interfacing with the user to output a selection signal for selecting the metadata file to be executed from the storage unit.

28. The method of claim 23, wherein the broadcast data file comprises an audio/video file and an application file.

29. The method of claim 23, wherein the metadata file comprises the package information regarding elements of the broadcast data file and electronic program guide information.

30. A computer-readable recording medium storing a computer program for executing a method of backing up broadcast files stored in a digital broadcast apparatus, each of the broadcast files comprising a broadcast data file and a metadata file including package information regarding elements of the broadcast data file, the method comprising:
analyzing package information included in a metadata file received from the digital broadcast apparatus and extracting at least one of storage location information and file name information regarding a broadcast file corresponding to the metadata file from the package information;
transmitting a message to the digital broadcast apparatus requesting the broadcast data file corresponding to the at least one of the storage location information and the file name information; and
storing the broadcast data file received from the digital broadcast apparatus and the metadata file in a storage unit in response to the message.

31. A computer-readable recording medium storing a computer program for executing a method of backing up broadcast files stored in a digital broadcast apparatus, each of the broadcast files comprising a broadcast data file and a metadata file including package information specifying that the broadcast data file is packaged together with the metadata file, the method comprising:
analyzing package information included in a metadata file received from the digital broadcast apparatus and extracting at least one of storage location information and file name information regarding a broadcast file corresponding to the metadata file from the package information;
transmitting a message to the digital broadcast apparatus requesting the broadcast data file corresponding to the at least one of the storage location information and the file name information;
converting the package information included in the metadata file so that the at least one of the storage location information and the file name information can be changed; and
storing the broadcast data file received from the digital broadcast apparatus in a storage unit in response to the message using the converted package information and storing the metadata file containing the converted package information.

32. A method of backing up a broadcast data file stored in a digital broadcast apparatus, the method comprising:
extracting at least one of storage location information and file name information regarding the broadcast data file from a meta data file including information on the broadcast data file;
receiving the broadcast data file corresponding to the at least one of the storage location information and the file name information from the digital broadcast apparatus; and
storing the received broadcast data file.

33. A method of backing up a broadcast data file stored in a digital broadcast apparatus, the method comprising:
extracting at least one of storage location information and file name information regarding the broadcast data file from a meta data file including information on the broadcast data file;
receiving the broadcast data file corresponding to the at least one of the storage location information and the file name information from the digital broadcast apparatus; and
converting the at least one of the storage location information and the file name information included in the meta data file so that the at least one of the storage location information and the file name information can be changed; and
storing the received broadcast data file using the converted at least one of the storage location information and the file name information of the meta data file.

34. A method of providing a broadcast data file stored in a digital broadcast apparatus, the method comprising:
generating a meta data file including information on the broadcast data file and transmitting the generated meta data file to an external apparatus;
receiving a broadcast data file request message including at least one of storage location information and file name information regarding the broadcast data file from the external apparatus; and
detecting the broadcast data file based on the broadcast data file request message and transmitting the detected broadcast data file to the external apparatus,
wherein the meta data file includes the at least one of the storage location information and the file name information regarding the broadcast data file.
